(19) United States
(12) Patent Application Publication
(10) Pub. No.: US 2021/0252361 A1
(43) Pub. Date: Aug. 19, 2021

(54) Net Attachment System

(71) Applicant: Custom-Pak, Inc., Clinton, IA (US)

(72) Inventor: Steven Dean Eggers, Clinton, IA (US)

(21) Appl. No.: 17/307,484

(22) Filed: May 4, 2021

Related U.S. Application Data
(63) Continuation-in-part of application No. 15/992,792, filed on May 30, 2018.

(51) Int. Cl. A63B 63/08; A63B 71/02

(52) U.S. Cl. CPC A63B 63/083; B29C 69/02; A63B 2071/026; A63B 71/023

(57) ABSTRACT

A net securing system and method of securing the net including a blow molded part with a plurality of holes, channels, and vertically tapered clips. Each of the plurality of vertically tapered clips is spaced apart from a central vertical axis of the holes at a distance greater than the hole width. In many embodiments, the net securing system has at least one protrusion on the inner surface of the vertically tapered clip. The net securing system secures a sports net when part of a net is inserted through the hole, around the vertically tapered clip and pinched within the channels. The net securing system may also include a backboard, a base connected to the backboard by a support rod, an attachment support connected to the support rod, a rim, and a net. Also disclosed is a method of forming the net securing system.

### PRIORITY CLAIM

This application is a continuation-in-part of U.S. application Ser. No. 15/992,792, filed May 30, 2018, the entirety of which is incorporated by reference.

### FIELD OF THE INVENTION

The following relates to a system for attaching a net to a rim or other device. In particular embodiments, the system is used for securing a net to the goal structure for a sports goal, which in certain embodiments could be a basketball hoop.

### BACKGROUND OF THE INVENTION

Nets are used in a wide array of devices such as sports goals among others. The nets are typically secured to a rigid member. Rims come in several different materials, each with its own advantages. Metal basketball rims, for example, are long lasting and durable and most accurately mimic the rims used in college and professional sports. They use welded elements configured similar to two springs welded together and extending in reverse directions. The net is wound round these spring like pieces and secured to the rim. While effective for metal rims, the spiral nature of these attachments would not be practical for molded plastic parts. Plastic rims, such as blow molded rims, are most commonly used when a lightweight less expensive solution is sought, such as use with children's toys. However, these plastic rims also need secure netting and not be prone to net slippage or rim breakage.

A solution to securing nets to plastic rims has been provided in U.S. Pat. No. 4,793,611, but this solution provides only “T” shaped extensions which can easily allow the net to become undone and detached through repeated use. U.S. Pat. Nos. 5,082,261 and 5,405,132 provide generally flat tabs with holes therein, but this solution also suffers the disadvantage of becoming undone through repeated use because the net can work itself free from the flat tab and then become pulled out of the hole. Particularly, because the bottom of the loop formed around the corresponding tab is generally not prevented from moving outwardly, repeated use of the net can cause the loops to become undone. Furthermore, these types of tabs are difficult to tool as a mold created opening.

Blow molded two wall hollow rims provide the strongest light weight rim, thus reducing material costs. However, it is difficult to blow mold two wall hollow rims in a close and exact way. Historically blow molded rims have been created with the addition of die punch nesting and action. But this adds additional steps and expense to the manufacturing process, in addition to the downside of net loosing or unwanted release over repeated use when the tabs bend or break. Broken tabs are a choking hazard for young children as well as resulting in sharp edges capable of causing harm. An advantage would be to use a blow molded rim with compression molding for detailed net attachment pieces, which would allow for a completely smooth one piece rim that is strong yet economical to make while being safe for children of all ages.

Therefore, it is desirable to provide a fastening system for a net that is easy and inexpensive to manufacture while being both easy to use and stronger and more secure than prior art solutions such that the fastening system is durable for repeated use over time.

### SUMMARY OF THE INVENTION

Disclosed herein is a secure attachment system for a net. Specifically, the disclosure provides an improved attachment system that allows a net to be secured to plastic rims and the like, particularly blow molded plastic rims.

In one aspect, a secure attachment system is a rim with a continuous outer section and inner section. The inner section has a plurality of holes and an inner face with a plurality of vertically tapered clips adjacent to the holes. The rim also includes a plurality of channels formed from the vertically tapered clips and the outer edge of the holes wherein the channels can pinch a net.

In most embodiments, the secure attachment system is a unitarily formed blow molded rim. In many embodiments, the secure attachment system is part of a complete basketball goal, which also includes a backboard, a support, and a base.

Also disclosed are methods of forming a sports net rim and securing a sports net.

Additional particular features and advantages of the disclosed embodiments will become more apparent from consideration of the following drawings and accompanying detailed description.

### BRIEF DESCRIPTION OF THE DRAWINGS

FIG. 1 is a perspective view of a basketball rim assembly.

FIG. 2 is a top view of two embodiments of the disclosed rim.

FIG. 3 is an expanded view of one of the pluralities of holes and vertically tapered clips of FIG. 2.

FIG. 4 is a partial cutaway perspective view of the rim of FIG. 2.

FIG. 5 is a top partial view of the rim of FIG. 2 showing both the outer rim section and inner rim section.

FIG. 6 is a bottom partial view of the rim of FIG. 2. FIG. 6 does not show the outer rim section.

FIG. 7 is a section view along line 6-6 shown in FIG. 5.

FIG. 8 is a placement view of the section view of FIG. 7.

FIGS. 9-12 show the process of installing a net on the disclosed rims.

### DETAILED DESCRIPTION

Referring now to the drawings, wherein like reference numerals designate corresponding structure throughout the views. The following examples are presented to further illustrate and explain the present invention and should not be taken as limiting in any regard.

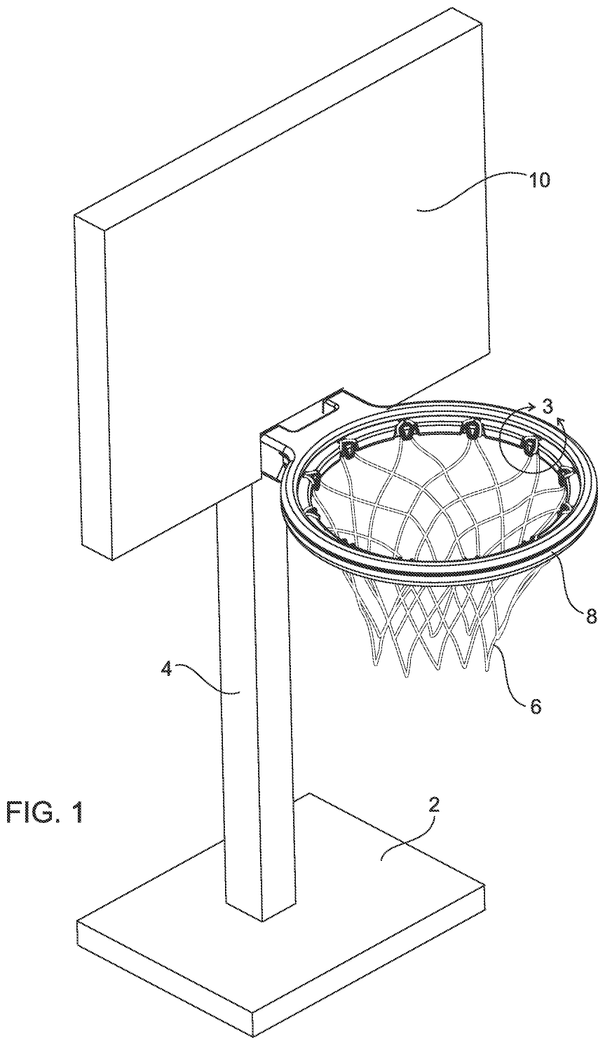

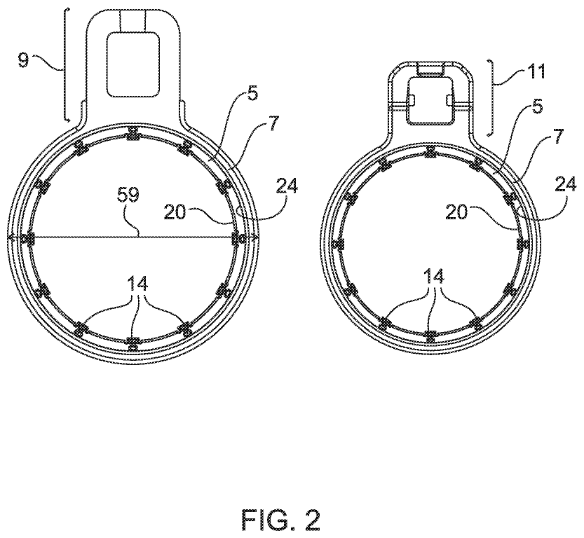

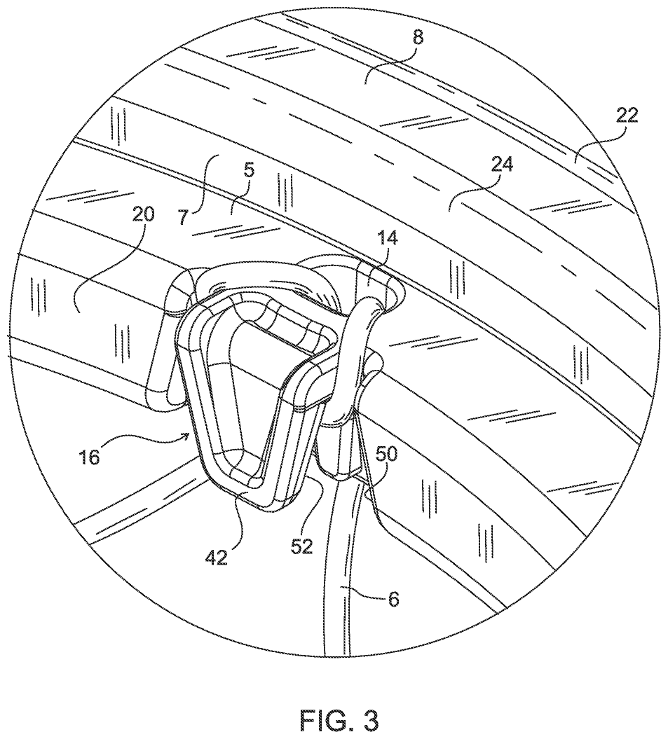

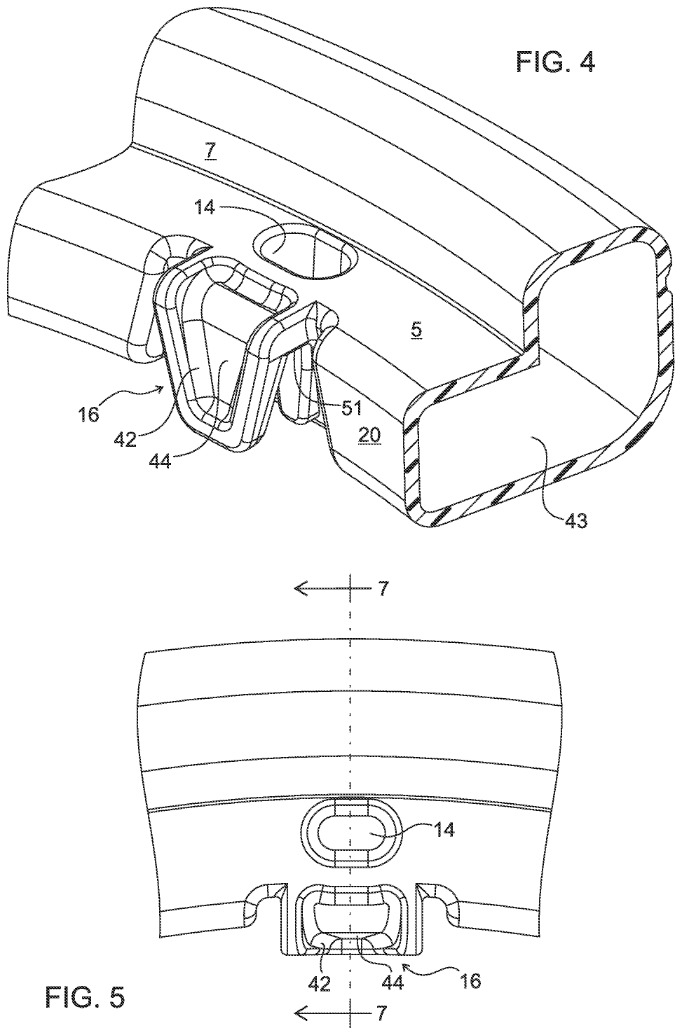

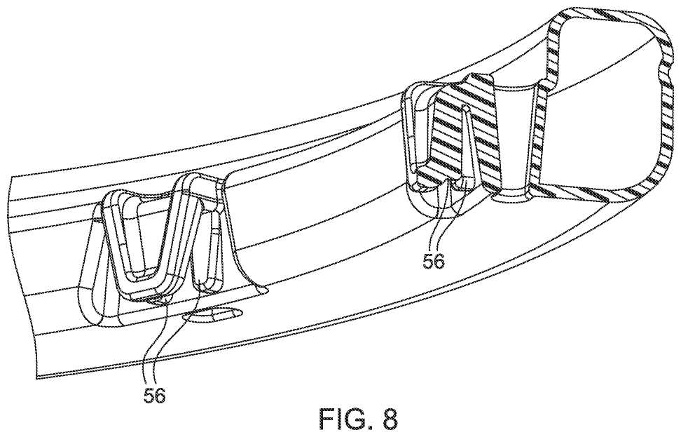

FIG. 1 shows an assembled basketball hoop system with a base 2, support rod 4, net 6, rim 8, and backboard 10. These parts are secured together to create a basketball goal. FIG. 2 shows two examples of the rim. FIG. 2 demonstrates rim 8 with two different types of attachment support, 9 and 11, which allow assembly to support rod 4. In one embodiment, attachment supports are in the same plane as the rest of rim 8. In other embodiments, attachment supports are in a plane either above or below the rest of rim 8. However, the type of attachment of rim 8 to support rod 4 is not meant to be limiting as long as an attachment support can be unitarily molded with rim 8. Nor is the diameter of rim 8, as measured along line 59 limiting. In some embodiments, the diameter will be about 16.5 inches. In other embodiments, the diameter will be about 14.5 inches. FIGS. 1-2, and in more detail FIGS. 3-4, show that rim 8 includes an inner section 5 and outer section 7. The width of outer section 7 is thicker than the inner section 5, which is best seen in FIG. 3. FIG. 3 is an expansion of the area designated as 3 in FIG. 1. As demonstrated in FIG. 2, inner section 5 has a number of holes 14 therein which are spaced around the perimeter of inner section 5 between inner face 20 and inner edge 24 of outer section 7. In the embodiment shown in the figures, the rim is circular and the holes are placed around a circumference. However, as is understood by the skilled artisan, the shape of the rim is not meant to be limiting and other shapes such as semi-circular or square are contemplated. Inner section 5 and outer section 7 will generally be the same shape. Outer edge 22 of outer section 7 defines the outer perimeter of rim 8. Referring to FIG. 7, holes 14 have a central vertical axis 13, outer hole wall 15, inner hole wall 17, inner surface of outer hole edge 19, outer surface of inner hole edge 21, outer surface of outer hole edge 49, and hole width 23.

As best shown in FIG. 3, in one embodiment, also within inner face 20 are a number of vertically tapered clips 16 positioned adjacent or next to each of the holes 14. Vertically tapered clips 16 include outer surface 27 and inner surface 29. Although the clips shown in the embodiment are vertically tapered, untampered clips i.e. square shaped clips are also anticipated. In the embodiment shown in FIG. 7 central vertical axis 13 is tilted slightly left (towards the inner surface) and outer surface of vertically tapered clip 27 is positioned such that central vertical axis 13 and an axis of outer surface 27 of vertically tapered clip 16 intersect. In another embodiment, the axis of outer surface 27 of vertically tapered clip 16 may also be angled further outward with respect to vertical. In certain cases, the angle of inner surface 29 of vertically tapered clip 16 and the angle of central vertical axis 13 form an acute angle which is preferably less than 45 degrees. In further aspects, this angle may be preferably less than 30 degrees or less than 20 degrees. In other embodiments, hole 14 may be shaped such that outer surface 27 of vertically tapered clip 16 and central vertical axis 13 are parallel.

In many embodiments, vertically tapered clip 16 comprises a rib 42 and inner recess 44. Rib 42 provides enhanced rigidity to vertically tapered clip 16. In certain embodiments, rib 42 may be hollow such that an air channel passes through rib 42 and into inner cavity 43 of rim 8. Inner recess 44 may be formed by two faces of molten plastic being fused or welded together during the molding process. In one embodiment, vertically tapered clip 16 is formed using compression molding.

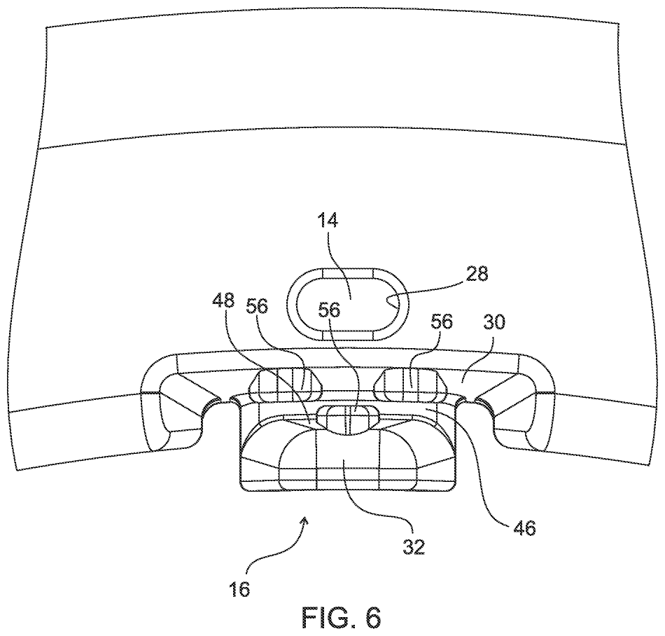

In certain embodiments, such as is shown specifically in FIG.5, inner surface 29 of vertically tapered clip 16 has one or more protrusions 56 to further keep net 6 in place. In the demonstrated embodiments, the protrusions are tapered protrusions. However, circular protrusions, as well as other shapes are contemplated. In the embodiment shown in FIG. 5, outer surface of outer hole edge 49 also has one or more protrusions. In the disclosed embodiments, there are three similarly sized protrusions oriented in a triangular manner. However, the skilled artisan understands that the number of protrusions 56, including the number of protrusions on either inner surface 29 of vertically tapered clip 16 or outer surface of outer hole edge 49 can vary. For example in other embodiments, there will be two protrusions or four protrusions. There is also no requirement that the protrusions all be the same size or shape. Generally protrusions 56 are placed such that they center at the midpoint of inner surface 29 of vertically tapered clip 16. In some embodiments, inner surface 29 of vertically tapered clip 16 and outer surface of outer hole edge 49 do not have protrusions.

Hole 14 includes bottom side 28 and top side 26, wherein the difference between top side 26 and bottom side 28 defines depth 55 of hole 14. Hole 14 also includes top surface of hole top side 39, top surface of hole bottom side 41, and bottom surface of hole bottom side 43. As shown, vertically tapered clip 16 narrows downwardly towards vertically tapered clip end 32. Between vertically tapered clip 16 and hole 14 is channel 30, which is configured to hold part of the net therein once installed. In one embodiment, channel 30 holds the net by pinching it. Channel 30 extends from top 31 to vertically tapered clip end 32 to define channel depth 33. Generally vertically tapered clip end 32 is aligned with bottom side 28, however, channel depth 33 can vary as long as it is greater than the thickness of the net (e.g. the rope the net is made of). In certain embodiments, the length of the portion of net 6 brought through hole 14 is at least twice channel depth 33 or at least twice the height of vertically tapered clip 16. As shown in the embodiment of FIG. 7, height of vertically tapered clip 16 is equal to depth 55 of hole 14. Nevertheless, different heights, such as a height greater than depth 55 of hole 14 or a height less than depth 55 of hole 14 are contemplated. In certain embodiments, channel depth 33 is at least 10% of hole depth 55. However, additional channel depths are contemplated.

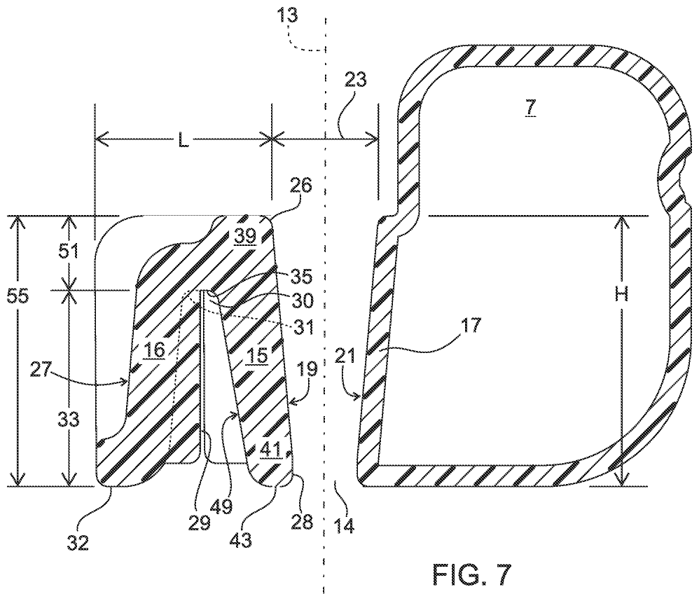

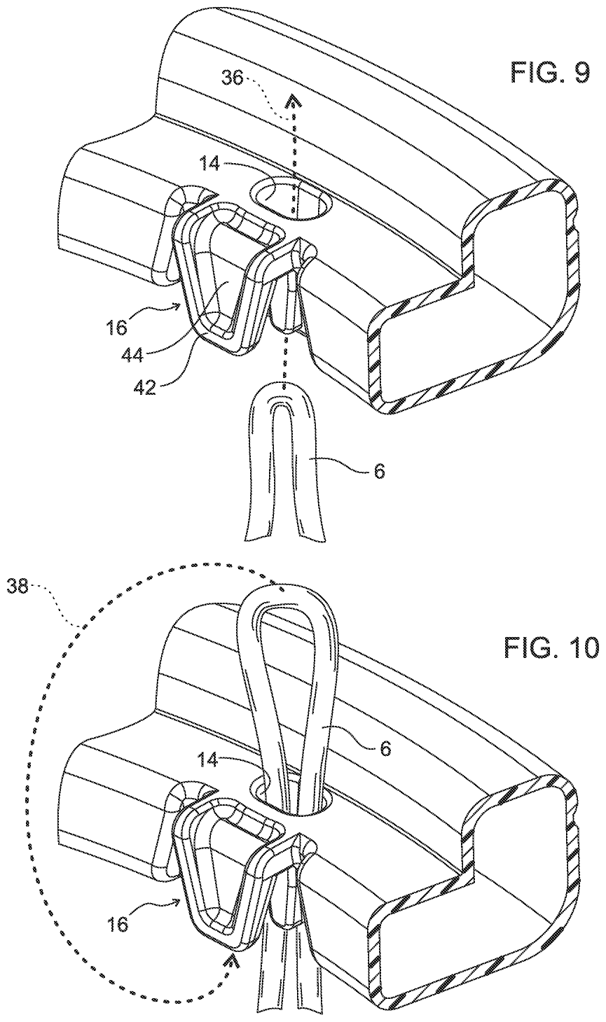

As shown in FIG. 7, vertically tapered clip 16 is spaced apart from central vertical axis 13 at a distance (L) which is greater than hole width 23 (W). The height of vertically tapered clip 16 (H), which is also hole depth 55 in the embodiment of FIG. 6, is measured from top surface of hole top side 39 to vertically tapered clip end 32. Channel depth 33 (D) is measured from vertically tapered clip end 32 to top 31. Further, depth of channel position 51 (C) is such that it is less than height of vertically tapered clip 16 (H). FIG. 8 further demonstrates the cutaway view of FIG. 7 in position along the rim.

FIG. 6 demonstrates that channel 30 in certain embodiments is curved in shape having outer curved portion 46 and inner straight portion 48. Outer curved portion 46 and inner straight portion 48 may be located at the base of the channel 30. In most embodiments, such as the one shown in FIG. 2 and FIG. 3, channel 30 generally narrows or tapers towards inner surface of channel top 31 between channel edge 50 and channel edge 52. As shown in FIG. 4, this helps ensure that net 6 is pinched in the top outer side of channel 51.

A disclosed method of forming a basketball rim includes, in a first step, blow molding the inner section 5, outer section 7, support attachment 9 or 11, and holes 14. In many embodiments, holes 14 are formed at an angle so as to provide an easier removal of the rim from the mold. Following the formation of the hollow rim sections, a plurality of vertically tapered clips 16 are compression molded onto inner face 20 of inner section 5 using a compression molding process. In many embodiments, rim 8 is made from a polymeric material. It is further meant to be understood that although a basketball rim is shown, other types of goals or nets needing to be secured can utilize the securing system described herein.

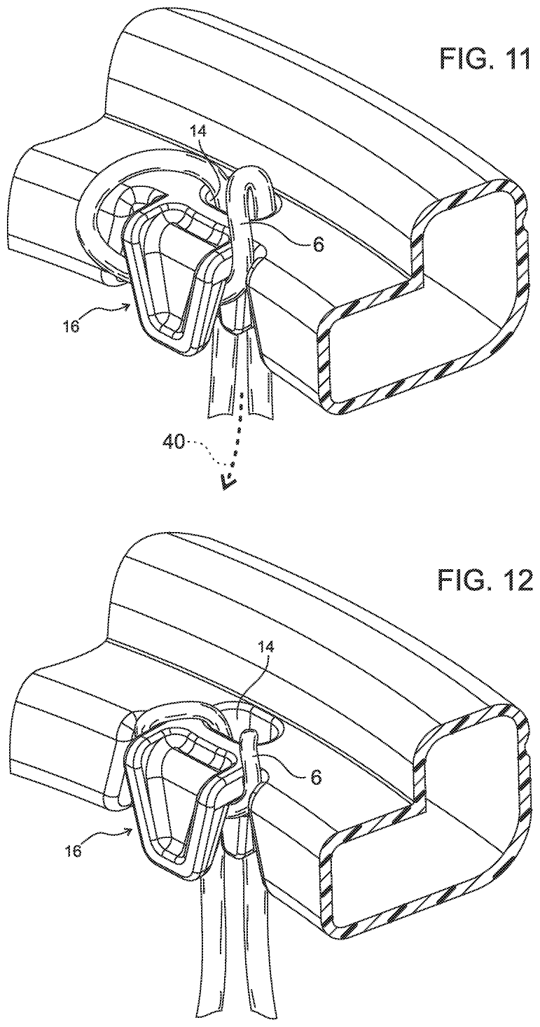

Also disclosed is a method of securing net 6. In a first step, shown in FIG. 9, a loop of net 6 is pulled upward 36 through hole 14. Then as shown in FIG. 10 by motion 38, in step 2, the loop of net 6 is pulled in a downward motion. FIG. 11 demonstrates how net 6 is then secured behind vertically tapered clip 16 and into channel 30, wherein it is pinched by top outer side of channel 51. FIG. 12 shows fully secured net 6. When net 6 is fully installed, tension by vertically tapered clip 16 causes force along net 6 to be directed to pull both toward inner surface outer hole edge 19 of hole 14 and against inner surface of outer edge 29 of vertically tapered clip 16, in a generally opposite direction of the downward weight tension on the net. In most embodiments, the hole 14 is adaptively sized to confirm to the thickness of net 6. Holes 14 are not meant to pinch net 6. Holes that are small enough to pinch are undesirable because they make net threading for attachment difficult.

Although the invention has been described with reference to a particular arrangement of parts, features and the like, these are not intended to exhaust all possible arrangements or features, and indeed many other modifications and variations will be ascertainable to those of skill in the art. The terms “first” and “second” are used to distinguish one element, set, data, object or thing from another, and are not used to designate relative position or arrangement in time.

1. A device comprising:
a continuous outer section; and
a continuous inner section, wherein the continuous outer section and the continuous inner section are the same shape, further wherein the continuous inner section comprises:
a plurality of holes, wherein each of the plurality of holes has an outer hole edge, and an inner hole edge;
an inner face of the inner section with a plurality of vertically tapered clips, wherein each of the plurality of vertically tapered clips is positioned adjacent to each of the plurality of holes, wherein each vertically tapered clip is configured to secure a net;
wherein when a net is inserted into one of the plurality of holes, a portion of the net is secured by the vertically tapered clip.

2. The device of claim 1 further comprising a plurality of channels formed from each of an inner surface of an outer edge of each vertically tapered clip and each of an outer surface of the outer hole edge of each of the plurality of holes, wherein each of the plurality of channels is capable of pinching a net.

3. The device of claim 1 wherein the continuous inner section and continuous outer section are a unitarily formed blow molded rim.

4. The device of claim 2 wherein each of the plurality of channels comprises a channel top, a channel bottom, and a channel depth defined by the difference between an inner surface of the channel top and a bottom surface of the channel bottom.

5. The device of claim 1 wherein each of the plurality of holes comprises a hole top side and a hole bottom side, and a hole depth defined by the difference between a top surface of the hole top side and a top surface of the hole bottom side.

6. The device of claim 4 wherein the channel depth is at least 10% of the hole depth.

7. The device of claim 5 wherein a distance between the hole top side and the inner surface of the channel top is less than the distance between a bottom surface of the hole bottom side and the hole top side.

8. The device of claim 2 wherein each of the plurality of vertically tapered clips is spaced apart from the central vertical axis at a distance greater than a hole width, wherein the hole width is a distance between an inner surface of the outer hole edge and an outer surface of the inner hole edge.

9. The device of claim 2 wherein the plurality of channels are tapered channels.

10. The device of claim 2 wherein each of the plurality of channels has an outer curved portion and a straight inner portion, further wherein the outer curved portion pinches the net.

11. The device of claim 1 wherein the vertically tapered clip comprises an outer hollow rib.

12. The device of claim 1 wherein the outer surface of the vertically tapered clip is parallel to the central vertical axis.

13. The device of claim 1 wherein the outer surface of the vertically tapered clip and the central vertical axis form an angle less than about 45 degrees.

14. The device of claim 1, wherein the outer surface of the vertically tapered clip and the central vertical axis form an angle less than about 30 degrees.

15. The device of claim 1 further comprising at least one protrusion on the inner surface of the vertically tapered clip.

16. The device of claim 15 comprising at least one protrusion on an outer surface of an outer hole edge.

17. The device of claim 1 further comprising an attachment support.

18. The device of claim 17 further comprising a backboard, a base connected to the backboard by a support rod, wherein the attachment support is connected to the support rod.

19. A method of forming a sports net rim comprising:
blow molding as a single piece, an inner section, an outer section, and a plurality of holes of a sports net rim; and
compression molding a plurality of vertical tapered clips internally to the plurality of holes in an inner face of the inner section.

20. A method of securing a sports net comprising:
pulling a loop of a sports net upward through one of a plurality of holes on a rim, and
pulling the loop of the sports net downward and around a vertically tapered clip and into a channel on the rim, wherein the sports net is pinched in the channel.
